(19) United States
(12) Patent Application Publication
(10) Pub. No.: US 2014/0186104 A1
(43) Pub. Date: Jul. 3, 2014

(54) CONNECTION FOR ELASTIC OR RIGID PANEL-TYPE COMPONENTS, PROFILED SLIDE, AND FLOOR COVERING

(71) Applicant: Peter M. Hamberger, Stephanskirchen (DE)

(72) Inventor: Peter M. Hamberger, Stephanskirchen (DE)

(73) Assignee: HAMBERGER INDUSTRIEWERKE GmbH, Stephanskirchen (DE)

(21) Appl. No.: 14/235,887

(22) PCT Filed: Jul. 30, 2012
(86) PCT No.: PCT/EP2012/064906

§ 371 Date: Mar. 12, 2014

(30) Foreign Application Priority Data
Jul. 29, 2011 (DE) 10 2011 052 300.6
Aug. 1, 2011 (DE) 10 2011 052 342.1
Sep. 5, 2011 (DE) 10 2011 053 283.8
Oct. 27, 2011 (DE) 10 2011 054 860.2
Dec. 7, 2011 (DE) 10 2011 056 146.3
Dec. 24, 2011 (DE) 10 2011 121 988.2
Mar. 20, 2012 (DE) 10 2012 102 350.6
Jun. 29, 2012 (DE) 10 2012 105 793.1

(51) Int. Cl. F16B 5/00; E04F 15/02

(52) U.S. Cl. CPC F16B 5/0032; E04F 15/02005
USPC 403/292

(57) ABSTRACT

The invention relates to a connection for panel-type components using a lock which acts along adjacent lateral edges of the components and which can be brought into engagement by lowering a component relative to a component that has already been installed. A profiled slide is guided in a movable manner on one component, the profiled slide being bringable into locking engagement with a locking recess on the other component for the purpose of a vertical lock. The profiled slide has a locking projection with a first guiding surface which is positioned diagonally with respect to the installation plane and which comes into contact with a locking surface of the locking recess during the lowering process such that a force component that causes a movement from a release position into a locked position is applied to the profiled slide.

The invention relates to a connection for elastic or rigid panel-type components, in particular for floor panels, in accordance with the preamble of claim 1, to a floor covering provided with such a connection, and to a profiled slide for such a connection.

Under the heading “click connection” a plurality of solutions are presently offered which enable the glueless connection of laminate or parquet floors/panels.

The long-side connection of the panels is performed via glueless tongue and groove joints with horizontal and vertical locking as described in EP 0 098 162 B1, WO 97/478 34 A1, or DE 199 62 830 C2. These connection profiles may be brought into locking engagement by angling or horizontal displacement. A problem with these solutions is the front-end connection of adjacent panels since they can only be connected by horizontal displacement (“hitting”). Such an installation is relatively complex. For this reason, connections have become prevalent in which the front-end connection takes place by angling a panel to be installed relative to a panel that has already been installed. Such connection profiles to be connected by angling are also referred to as “hook profiles” or “press button profiles”. With these profiles, a panel to be installed is positioned diagonally along the long sides of a panel that has already been installed, wherein, for instance, a tongue of the panel to be installed immerses into a groove of the panel that has already been installed. Subsequently, the panel to be installed is angled from its diagonal position downward, with the tongue immersing completely into the groove and the horizontal locking means at the long sides engaging each other, so that the two panels are locked along the longitudinal edge. During this angling process the front-end profiles of the panel to be installed are also brought into locking engagement with a front-end adjacent panel without a “hitting” in the horizontal direction being necessary.

Such connection is, for instance, known from EP 1 276 941 B1. In this known solution, a locking projection immerses into a locking recess of the other panel during angling, wherein a locking projection of the panel then snaps into a locking recess of the other panel for vertical locking. These locking projections and locking recesses must, caused by the construction, be relatively small since a catch mechanism by elastic deformation of the material is possible. This document also illustrates a variant in which the locking projection is effected by an inserted flexible element.

Similar solutions are disclosed in DE 10 2005 002 297 A1 and in EP 1 415 056 B1.

EP 1 650 375 A1 describes a solution in which a tongue is inserted into an accommodation groove of a component for locking, said tongue being approximately U-shaped or arcuate in top view. In the unlocked condition, the basis of the U-shaped tongue projects toward the other panel and is deformed inwardly into the accommodation groove of the other panel during angling, and then, due to its resilience, snaps after the complete angling of the panel into an accommodation such that the panels are fixed in position at the front end.

A disadvantage of all these solutions is that a comparatively large force is required for locking since the elastic force of an insert has to be overcome or else the basic material of the panel, for instance, HDF/MDF has to be deformed elastically so as to effect the catch mechanism.

Recently, so-called “side push systems” have been launched in the market in which a slide is incorporated at the front end of a panel which, by arranging a further panel at the long side, is adapted to be brought into locking engagement with a front-end adjacent panel that has already been installed. The first workable side push solution is described in DE 10 2007 018 309. Similar solutions are also explained in documents DE 10 2006 037 614 and WO 2008/004 960 A2 which were published later than the afore-mentioned one.

A disadvantage with these “side push solutions” is that the slide has to project at the long side—in the case of an undesired displacement of the slide position prior to the installation the establishing of the long-side connection is possible with increased effort only.

Recently, elastic floors of plastic material (PVC, PP, PET, etc.) have also been designed with connections that are used in the case of rigid, panel-type floors.

As compared to this, it is an object of the invention to provide a connection for elastic or panel-type components, in particular floor panels, a floor covering provided with such a connection, and a profiled slide, which enable installation with reduced effort.

This object is solved by a connection with the features of claim 1, and a floor covering with the features of the independent claim 20, and a profiled slide with the features of claim 21, respectively.

Advantageous further developments of the invention are the subject matters of the subclaims.

In accordance with the invention, such a connection for elastic or panel-type components, in particular floor panels, comprises a lock which acts along adjacent lateral edges of two components which can be brought into engagement by lowering or angling one of the components relative to the component that has already been installed. A profiled slide is guided in a movable manner on one component, said profiled slide being adapted to be brought into locking engagement with a locking recess on the other component for the purpose of a vertical lock at said lateral edge.

In accordance with the invention, the profiled slide is provided with a locking projection having a first guiding surface that positioned diagonally relative to the installation plane. A locking surface of the locking recess will run thereon during the angling process, so that the profiled slide is movable from a release position into a locked position. This movement is performed directly from the release position into the locked position and not, as in prior art, by a tongue first being elastically deformed and then snapping back. The slide may be mounted on the component that has already been installed or on the component to be installed.

Such a solution has the advantage that locking is effected alone by the lowering or angling of a component, wherein the profiled slide is pushed to slide into its locked position without noticeable resistance. Thus, a resilient force or elasticity of a locking projection such as with the afore-described “push button profiles” need not be overcome to effect the locking engagement.

In these known systems, the lowering of a panel toward the other panel that has already been installed causes the tongue or the locking projection to be elastically deflected inwardly. It will then snap back into its locked position after the complete lowering of the panel. In the system according to the invention the profiled slide is moved directly in the locking direction without noticeable resistance.

As compared to the side push systems the system according to the invention has the advantage that the arranging of a third panel at the long side is not necessary. Accordingly, the connection according to the invention is, on the one hand, characterized by a high installation comfort and, on the other hand, by little effort with respect to the device technology.

In one embodiment of the invention the guiding surface in the locked position engages behind the locking surface of the locking recess, wherein the locking projection comprises a support face being in contact with an abutment wall of the locking recess in this locked position. This double-sided contact of the profiled slide with the lowered/angled component causes a reliable horizontal and vertical locking since the profiled slide is positively locked with the angled/lowered component.

The connection is particularly uncritical in the case of a change of position of the profiled slide prior to the installation if the locking projection is designed such that during lowering the guiding surface runs on the locking surface, so that the profiled slide, during further lowering, is, by a force component acting in the locking direction, movable in the locking direction until the support face is in contact with the abutment wall in the locked position. The slide is thus restraint-guided in the direction of its locked position.

For the sake of good order it is pointed out that the term “run on” does not necessarily define that the moving component runs on a stationary component. This term is used in the instant application also if a face provided on a component that has already been installed gets, during the lowering process of another component, into contact with a corresponding face of this component. This means that the face section that runs on may be provided on the component that has already been installed or on the component to be installed.

In one embodiment the guiding surface and the support face may be designed to be parallel to each other.

The locking may, for instance, also be improved in the case of an uneven underground in that the abutment wall or else the locking surface are designed such that a substantially linear or punctual abutment exists in this region and undesired releasing is thus prevented. This effect may, for instance, be caused by a concave curvature of the abutment wall, so that no extensive contact exists between the locking surface and the abutment wall. It will be understood that other geometries may also be chosen to avoid an extensive contact in the area between the locking surface and the abutment wall. On principle, the contact area between the guiding surface and the support face might also be designed such that no extensive contact exists in the locked position, so that undesired releasing is avoided.

The pitch angle of the guiding surface may be between 30° and 60°, preferably approximately 50°.

In an embodiment that is particularly easy to manufacture the locking projection has, in a view parallel to the installation face, approximately the shape of a triangle, with the guiding surface being provided at the rear side. Furthermore, the profiled slide is designed with a front face facing the locking recess, which is spaced apart from a rear wall of the locking surface in the locked position.

In one embodiment of the invention the locking projection of the profiled slide is provided with a slot. This slot ends preferably in a front face of the locking projection. Due to the design of the locking projection which is elastic to a certain extent the movement process from the release position into the locked position can be improved.

A connection in which a shearing block is provided on the first or the second component which rests upon an extended locking lip of the other component in the locked position and which is engaged behind by a horizontal locking projection of the locking lip has proved of particular value.

A shearing block of a component is preferably designed with a beveled face that is, if the profiled slide projects too far in the locking direction, adapted to be brought into contact with a front face of the profiled slide to move it in counter-direction to the locking direction until the guiding surface is aligned with respect to the locking surface. In this variant an incorrect position of the profiled slide may thus also be compensated for if it is positioned too deeply in a guide groove of the first component.

Such a beveled face of the shearing block may be connected with the abutment face of the locking recess via a vertical face.

In one variant of the invention the profiled slide has a flat slide section guided in a movable manner in the locking direction in a guide groove of the first component.

The depth of a guide groove is preferably chosen such that the guide face is aligned with respect to the locking surface when the locking profile fully immerses into the guide groove. Thus, the wrong positioning of the slide in the first component which would aggravate installation is made difficult.

The shifting of the profiled slide in the front edge direction may be prevented by suitable stops.

The connection of the long sides of the components is preferably performed by a locking profile that is adapted to be brought into locking engagement by angling.

In one embodiment of the invention it is provided to form at least one flexible tongue on the profiled slide in the region of the flat slide section which projects from the flat slide plane. This flexible tongue is preferably oriented toward the locking projection.

The manufacturing of the flexible tongues is particularly simple if they are formed by areas of the flat slide sections that have been cut clear. These clear cuts are preferably made in U-shape, so that the “U” surrounds the flexible tongue. Such clear cuts can be formed in a relatively simple manner in the injection molding tool.

In order to improve the transverse elasticity of the profiled slide, the rear side of the flexible tongues may be provided with a slot.

These flexible tongues may have brake bumps engaging in the locked position behind a front face section of the component in which the profiled slide is guided. Thus, the moving back of the profiled slide from its locked position is reliably prevented.

Installation tests of the floor covering according to the invention have shown that an overshot, i.e. a vertical displacement between the adjacent components, may occur. Such an overshot may be avoided if the profiled slide is provided with support nipples through which the profiled slide is supported on the other component, i.e. on the component in which the profiled slide is not guided. Such support nipples may, for instance, be provided on the afore-mentioned flexible tongues. By the support nipple the profiled slide is also secured against shifting in the locked position.

The support face for the support nipple may, for instance, be provided by a cut in the adjacent component into which the support nipple immerges. In this process, it may engage behind a vertical face formed by the cut, so that the support nipple assumes the function of the above-mentioned brake bump.

In accordance with the invention it is preferred if the support nipple extends approximately in the same direction as the locking projection.

In accordance with the invention, the profiled slide may be provided in the component to be installed or else in the component that has already been installed. This means that in the latter case the component to be installed is lowered toward the profiled slide. It has turned out that the latter-mentioned variant has a certain advantage since in the case when the profiled slide is guided in the component to be angled, the upper flange of the groove is of relatively weak design and thus tends to stand up since no counteraction takes place in this region. This standing up in turn results in an overshot. If the profiled slide is now guided in the component that has already been installed, the lower flange of the groove will be wakened in correspondence with the inversion of the profile geometry, but this weakening does not result in a standing up in the effective area, but at most in the support area. There, however, this standing up does not play any role since an insulating layer or the like is usually provided to compensate for such standing up.

The flexible tongues may be deflected elastically to some extent during the movement of the profiled slide, so that the brake bumps or the support nipples formed thereon slide off without noticeable resistance during the movement of the profiled slide and then snap back into their predetermined position on reaching the locked position and thus prevent that the profiled slide can be moved back. The material strength of the flexible tongue is, if a brake bump is provided, chosen such that the latter one is accommodated in the guide groove of the assigned component in an elastically bent state and then snaps out in the locked state. If the flexible tongue is provided with a support nipple, the overall height of the flexible tongue and of the support nipple has to be chosen such that it may be pushed into the adjacent component until the support nipple gets into contact with the assigned support face in the locked position.

It is of advantage if the profiled slide is provided with a plurality of recesses or cuts. These recesses or cuts which extend diagonally to the longitudinal direction of the profiled slide provide it with a certain elasticity or resilience. The result of this is that the profiled slide is adapted to be deflected in sections in the direction of movement and is thus capable of adapting itself automatically toward the other component during the lowering process of the one component, so that squeezing of the areas which are successively getting into contact with each other during the lowering movement is avoided.

In contrast to the initially described prior art, the brake bumps and the support nipples merely prevent a certain back movement of the profiled slide. A snapping function in which some locking element is first of all deflected elastically against its tongue bias by the lowering of a panel and then snaps back again so as to lock is not available with these elements.

In accordance with the invention it is preferred if flat slide teeth are designed to be elastically deflectable. On principle, the brake bumps may be formed by notching material from the flat slide profile.

The profiled slide according to the invention preferably has a flat slide section that is guided in a guide groove of a component, and a locking projection effecting the horizontal locking with the other component.

The profiled slide may, as already explained before, be designed with at least one brake bump preventing inadvertent shifting back of the profiled slide into the guide groove.

In one variant of the profiled slide a plurality of flexible tongues are provided on the flat slide portion, with a respective brake bump or a respective support nipple being formed thereon. These flexible tongues have a certain elasticity enabling a sliding movement of the profiled slide within the guide groove and/or into the adjacent component, so that the brake bumps can be brought into the locked position or the support nipples into their support position.

The profiled slide is particularly simple to manufacture if a flexible tongue is designed by a clear-cut area of at least one flat slide tooth.

This clear-cut area may be approximately of U-shape and thus enclose the brake bump or the support nipple at least in sections. This U-shaped clearance cut forms the deflectable flexible tongue.

The sliding guiding of the guide section within the guide groove is facilitated if a plurality of nubs, preferably of plastics, is provided on the flat slide section by means of which the flat slide section slides off in the guide groove.

In order to avoid squeezing of the areas that are successively getting into contact during the angling of the one component in the direction of the other component, in particular the locking surface and the abutment wall, the profiled slide is designed to have a predetermined elasticity in the installing direction which enables the locking projection to slide into the locking recess of the other component without excessive resistance. This transverse elasticity may be provided by cuts or recesses of the profiled slide. These recesses may be provided on the flat slide section and/or else in the region of the locking projection.

Particularly good elasticity is achieved if such recesses are provided alternately on the flat slide section and on the locking projection.

The function of the profiled slide is further improved if the locking projection is chamfered or beveled laterally, i.e. on one or both end sections of the profiled slide. Such a lateral bevel of the locking projection may be provided with all embodiments described. The beveling prevents or at least reduces blocking or squeezing during angling.

The floor covering consisting of a plurality of floor panels with the connection according to the invention is characterized by being very simple to install, with the formation of gaps during heating periods being reduced to a minimum.

The connection according to the invention is not restricted to the use with panels for floors, wall or ceiling coverings. On principle, such a connection may be used with all applications in which planar, elastic or rigid components have to be connected with each other in a detachable manner. Thus, the connection may, for instance, be used in furniture industry for cabinet systems or the like.

Preferred embodiments of the invention will be explained in more detail in the following by means of schematic drawings. There show:

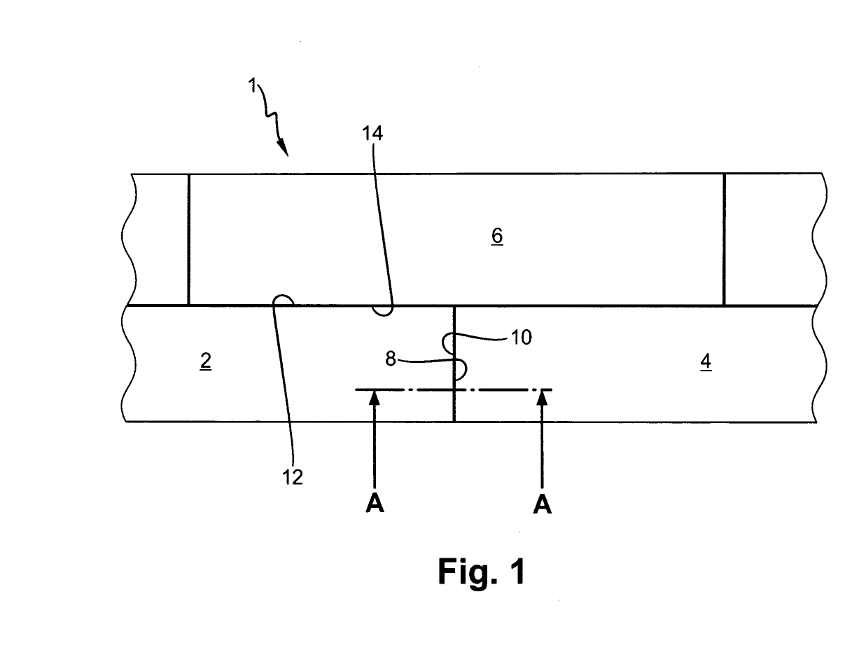

FIG. 1 a schematic illustration of a floor covering consisting of floor panels in accordance with the invention;

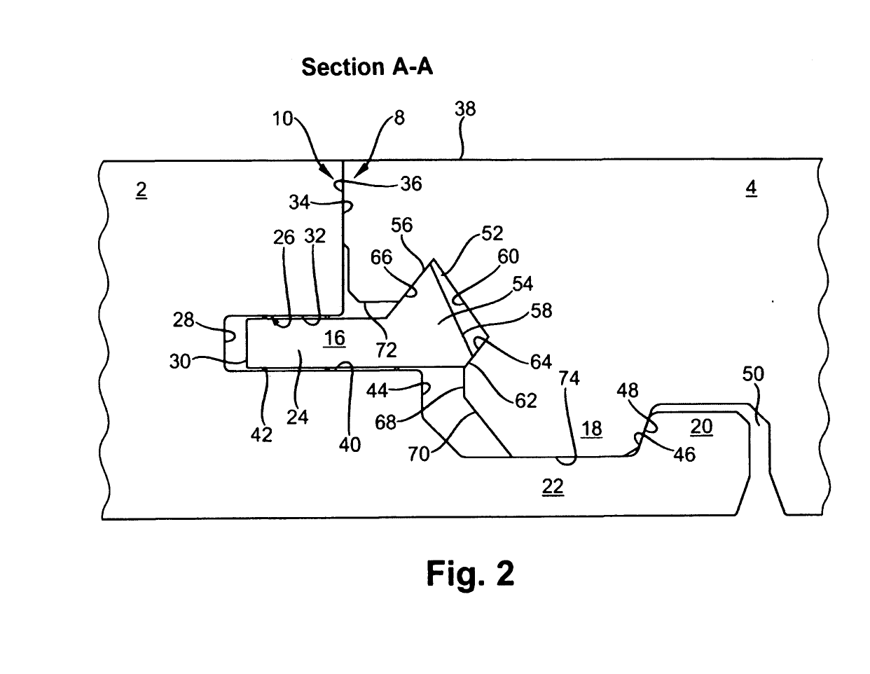

FIG. 2 a section along line A-A in FIG. 1;

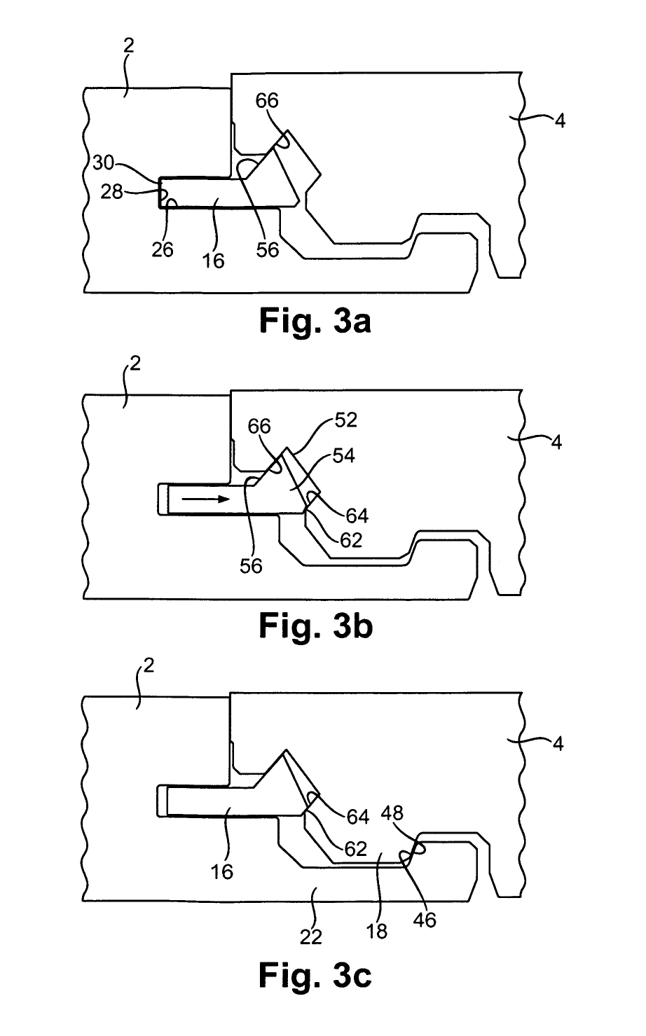

FIGS. 3a to 3d an installation process of two front-end adjacent floor panels with a connection according to FIG. 2;

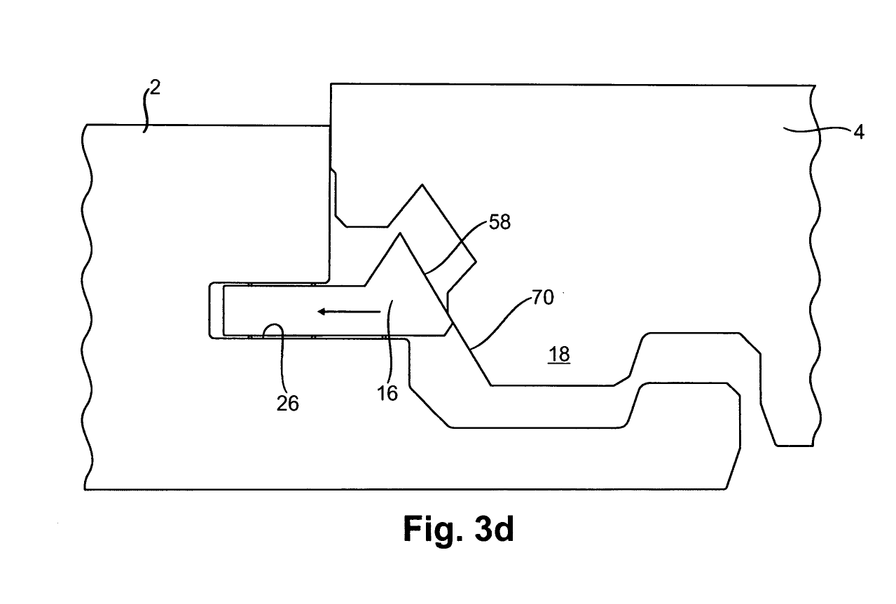

FIG. 4 a section along line A-A in FIG. 1 in a second embodiment;

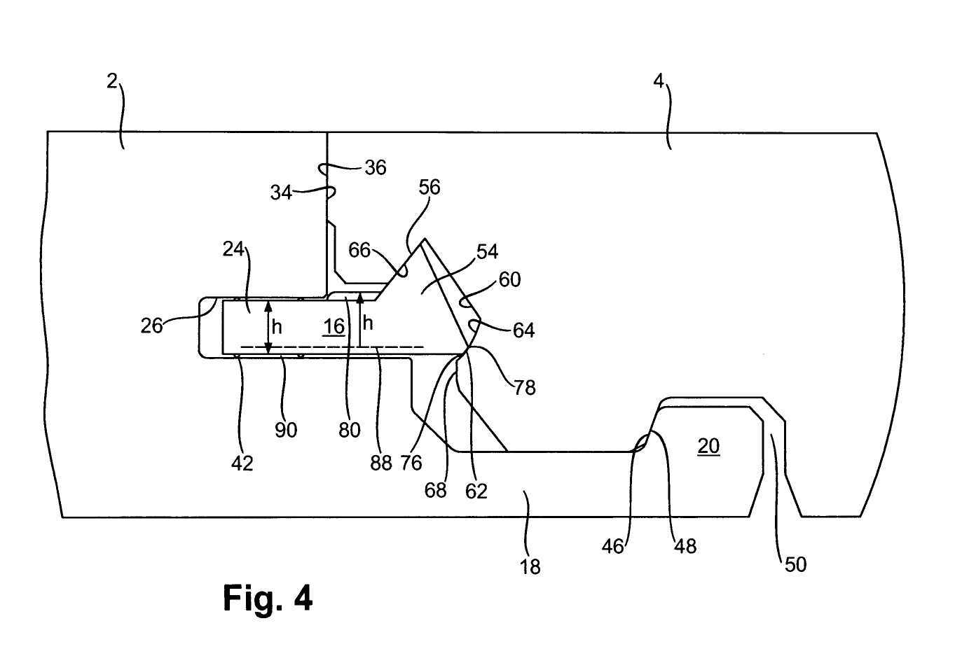

FIGS. 5a to 5f views of a profiled slide of the embodiment according to FIG. 4;

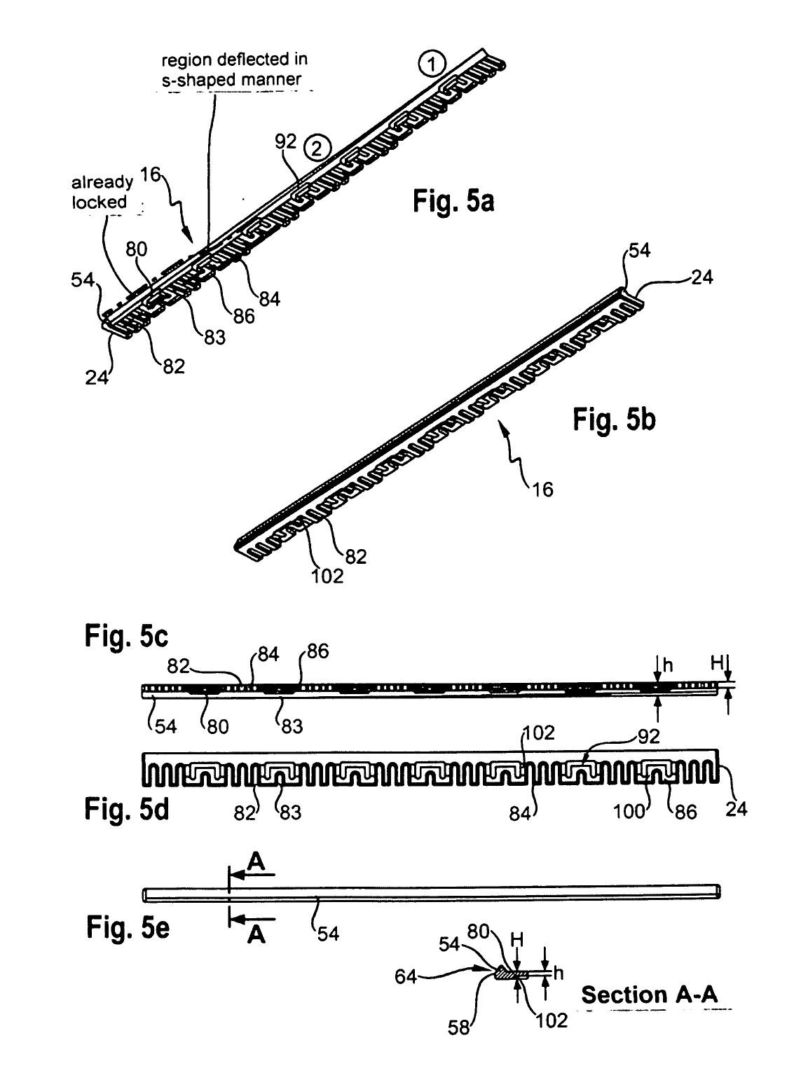

FIGS. 6a to 6c an installation process with floor panels provided with a connection according to FIG. 4;

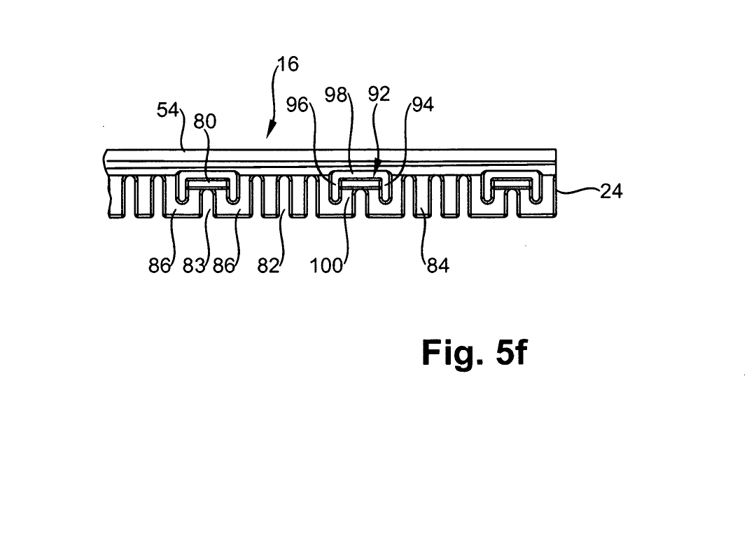

FIGS. 7a to 7c views of a further embodiment in which the profiled slide is mounted on the floor panel to be installed;

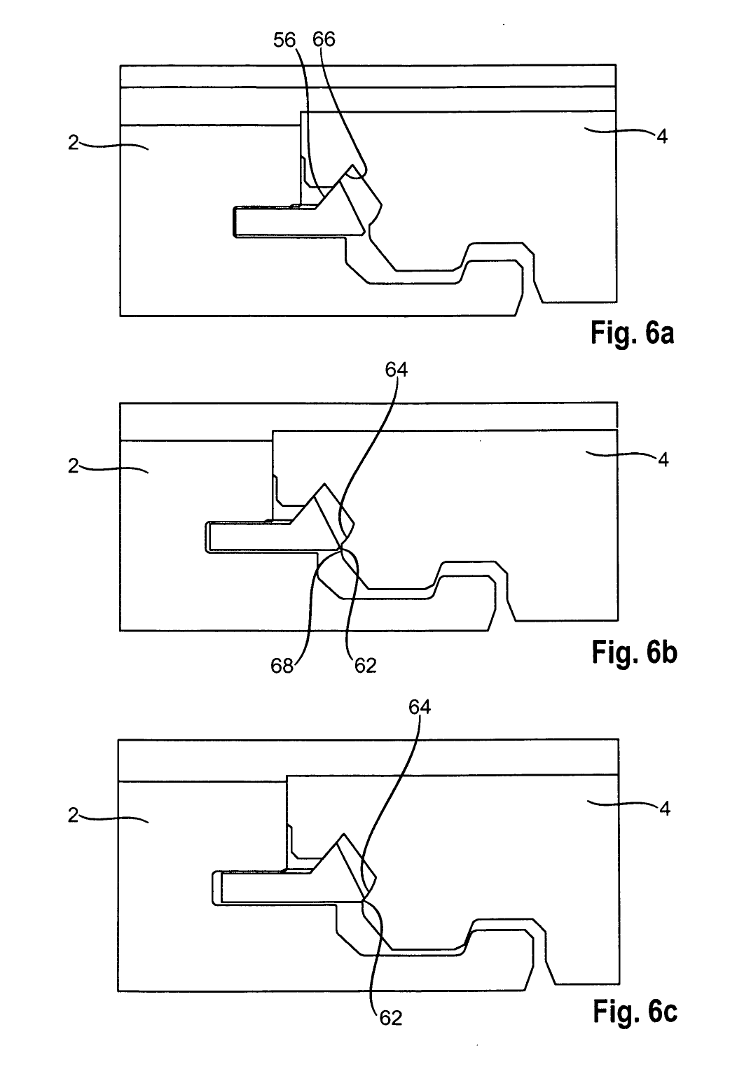

FIG. 8 a sectional view of a further embodiment of a connection;

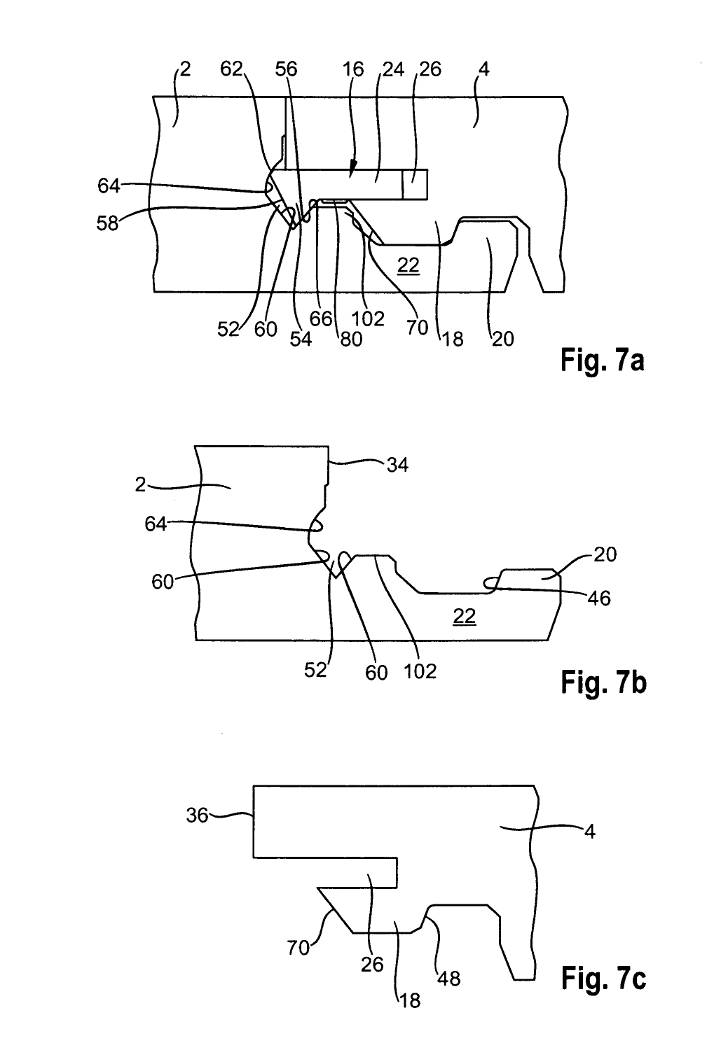

FIG. 9 a further embodiment of a profiled slide for a connection in accordance with the foregoing Figures;

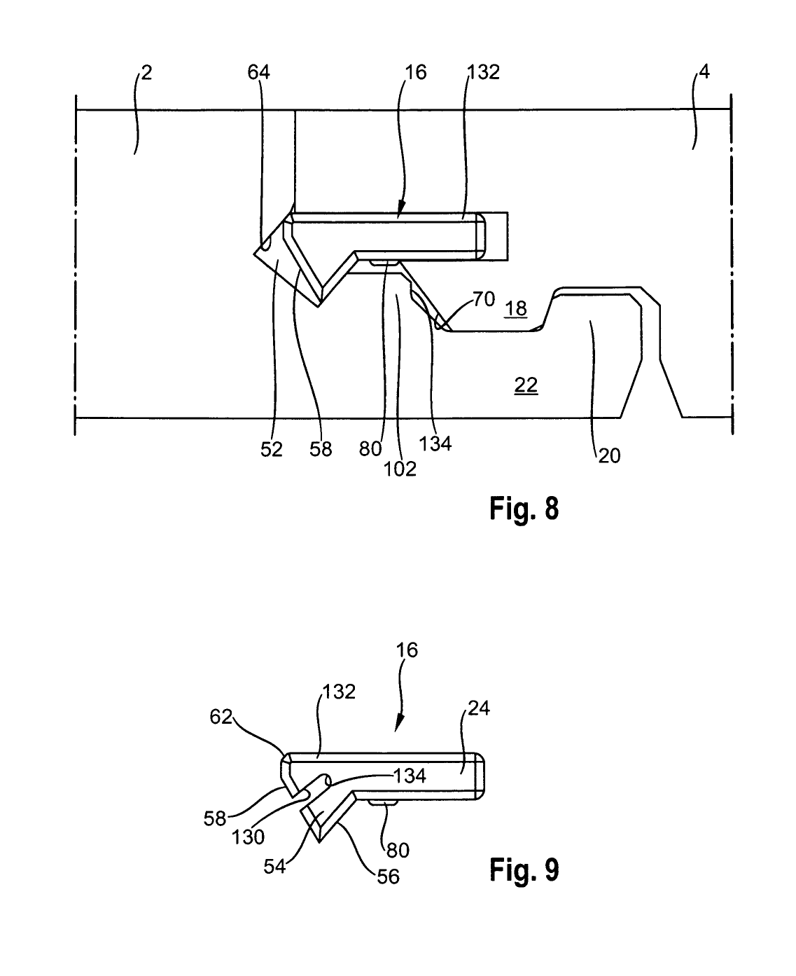

FIG. 10 an embodiment with a profiled slide comprising a support nipple;

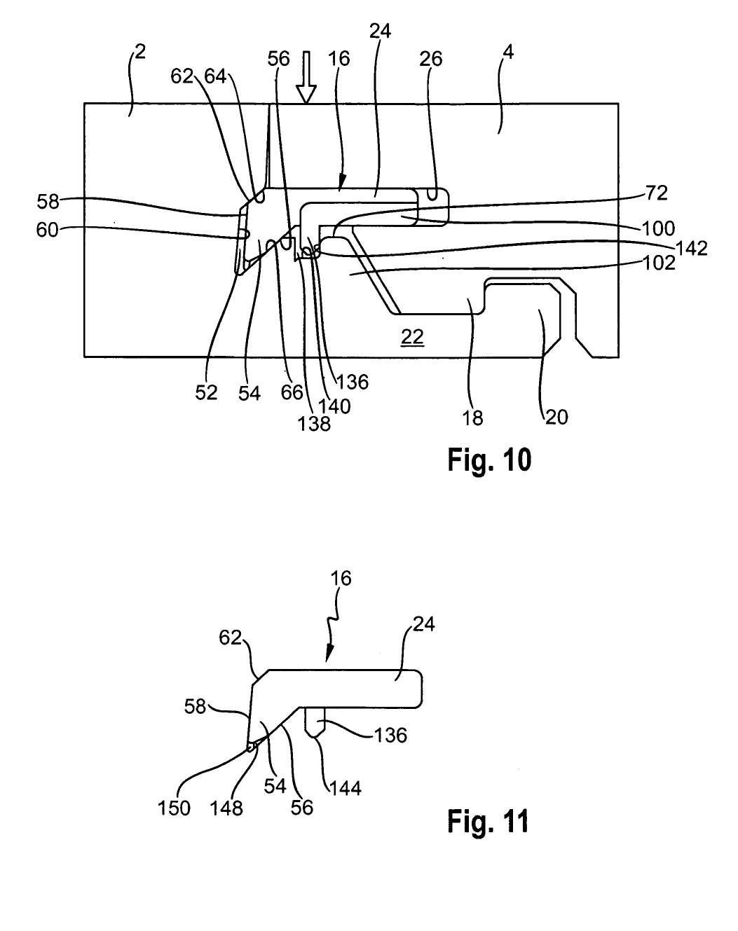

FIG. 11 the profiled slide of FIG. 10;

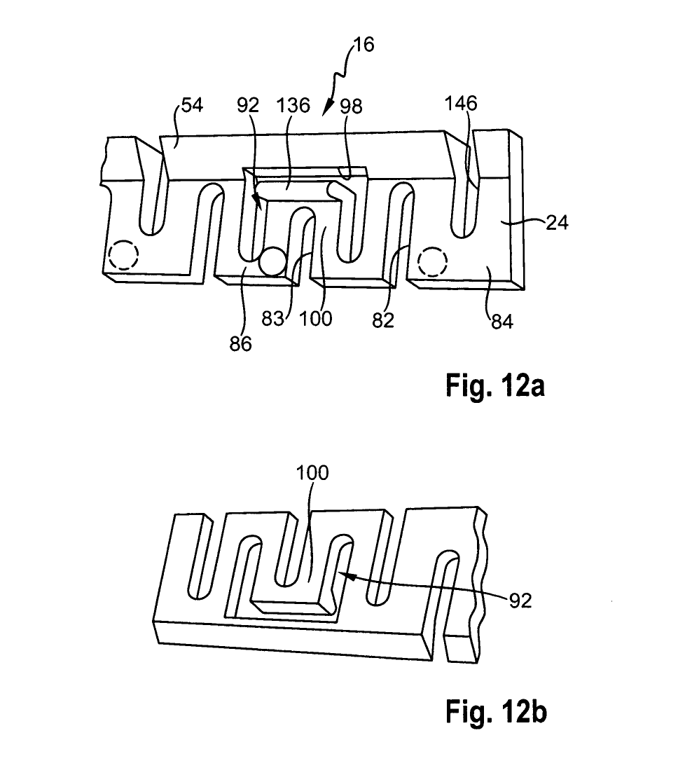

FIGS. 12a, 12b schematic detailed illustrations of the profiled slide of FIG. 10; and

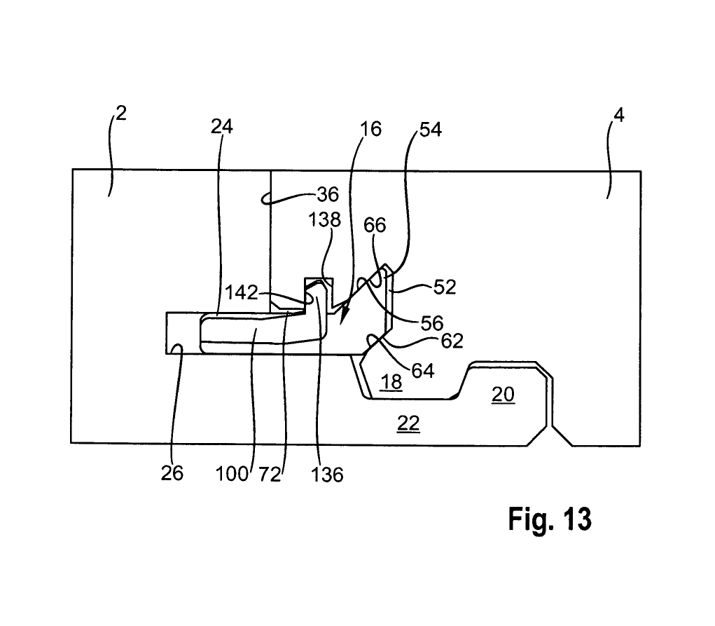

FIG. 13 an embodiment corresponding to FIG. 10, wherein the profiled slide is arranged in the component that has already been installed.

FIG. 1 illustrates a strongly schematized top view of a floor covering 1 consisting of a plurality of floor panels, in the following referred to as panels, three of which are by way of example designated with reference numbers 2, 4, 6 in FIG. 1. In the illustration of FIG. 1 the two panels 2, 4 contact each other at the front end along their front edges 8, 10. A longitudinal edge 12 of the panel 2 is connected with a longitudinal edge 14 of the panel 6. This longitudinal edge 14 is also connected with the adjacent longitudinal edge (which is not provided with a reference number in FIG. 1) of the further panel 4. The panels may, for instance, be designed as laminate or parquet floors.

The floor panel may be used for a comparatively rigid floor covering such as, for instance, a parquet floor, a laminate floor, or a tiled floor. On principle, the floor panel may also be designed with an elastic, soft cover face in the case of an elastic floor covering, for instance, a PVC floor or a floor of PVC substitute material. Such floors may also be designed with a carrier of plastics, HDF/MDF, or wood-plastics compound.

At the long sides locking profiles are formed, such as they are explained in the introduction of the description. With these profiles, for instance, the panel 2 is locked at the long side by arranging it diagonally with respect to the panel 6 that has already been installed, and by subsequent angling. The front-end connection of two adjacent panels 2, 4 will be explained by means of the following Figures.

FIG. 2 illustrates a section along the line A-A in FIG. 1 which thus extends through the two front edges 8, 10 of the panels 2 and 4, respectively. The vertical locking is, in accordance with the invention, performed by a profiled slide 16 while the horizontal locking is substantially performed by a shearing block 18 engaged behind in the horizontal direction by a horizontal locking projection 20 of an extended locking lip 22 and by the front-end abutment of the front edges 8, 10.

In the illustration of FIG. 1 the profiled slide 16 consists substantially of a flat slide section 24 that is guided in a guide groove 26 of the panel 2. In the illustrated embodiment this guide groove 26 is designed approximately as a square groove in the illustration of FIG. 2. A groove bottom 28 is formed in the illustrated locked position of the locking slide 16 at a distance to a front face 30 of the square-shaped flat slide section 24. In the illustration of FIG. 2 the guide groove 26 is confined at the top by an upper horizontal face 32 running at right angle to a front face section 34 of the front edge 8. A corresponding front face section 36 of the other panel 4 is in contact with the front face section 34 of the other panel 2 in the direction of the effective face 38 of the floor covering 1, wherein this contact need not necessarily be effected with press fit, but a certain clearance may also be tolerated.

A—in FIG. 1—lower part of the front face section 36 is recessed relative to the adjacent front face section 34.

A—in FIG. 2—lower horizontal face 40 of the guide groove 26 is extended beyond the plane of the front face sections 34, 36 to the right (illustration in FIG. 2), so that the flat slide section 24 is supported downwardly across a comparatively large area. In the illustrated embodiment the flat slide section 24 is provided with nubs 42 which reduce slide friction and improve sliding fit. It is, however, definitely also possible to renounce these elements and to guide the flat slide section 24 to slide flush along the horizontal faces 32 and 40.

The lower horizontal face 40 extends up to a vertical face 44 of the panel 2. From there, the locking lip 22 extends, at the end section of which the horizontal locking projection 20 is formed. It has an inclined horizontal locking surface 46 being in contact with a rear-side beveled face 48 of the shearing block 18 in the locked position, wherein the two faces 46, 48 extend in parallel.

The rear-side beveled face 48 of the shearing block 18 is confined by a recess 50 on the bottom side of the panel 4 into which the horizontal locking projection 20 immerses. The type of horizontal lock via a shearing block 18 resting on a locking lip 22 and being engaged behind by a locking projection 20 has also been implemented in prior art already, so that further explanations in this respect are superfluous.

The somewhat recessed portion of the front face section 36 of the panel 4 is followed by a locking recess 52 into which a locking projection 54 of the profiled slide 16 immerses in the illustrated locked position. This locking projection 54 has, in the illustration of FIG. 2, an approximately triangular profile extending in continuation of the flat slide section 24. The locking projection 54 is confined on the one side by an inclined guiding surface 56 which is inclined with respect to the horizontal (installation plane). In the illustrated embodiment this pitch angle is about 50°. The locking projection 54 is confined toward the right by a front face 58 extending at an acute angle to the guiding surface 56 and being arranged at a distance to a rear wall 60 of the locking recess 52 in the locked position. The front face 58 is followed by a support face 62 at the locking projection 54 which extends approximately in parallel to the guiding surface 56 in the illustrated embodiment and is in contact with an abutment wall 64 of the locking recess 52. This abutment wall 64 extends at a parallel distance to a locking surface 66 of the profiled slide 16 which the guiding surface 56 is in contact with. The locking surface 66 and the abutment wall 64 of the locking recess 52 thus also extend approximately in parallel to each other. In accordance with the illustration in FIG. 2 the distance between the front wall 58 and the rear wall 60 of the locking recess 52 increases toward the abutment wall 64. In the section according to FIG. 2 a vertical face 68 extends in continuation of the inclined abutment wall 64, which is then followed by an inclined face 70 of the shearing block 18.

The guiding surface 56 of the locking projection 54 transitions via a horizontal face 72 into the recessed portion of the front face section 36 of the panel 4. This horizontal portion 72 is distinctly spaced apart from the flat slide section 24 of the profiled slide 16.

The illustration of FIG. 2 reveals that the front-end horizontal locking between the two panels 2, 4 is substantially performed by the locking recess 20 engaging behind the shearing block 18 and by the contact of the front face sections 34, 36. The vertical locking is, on the one hand, performed by the resting of a floor face 74 of the shearing block 18 on the locking lip 22 and, on the other hand, by the support of the locking projection 54 of the profiled slide 16 on the abutment wall 64 and the locking surface 66. The forces introduced into the profiled slide 16 by the panel 4 are then introduced into the panel 2 via the flat slide section 24, so that the two panels 2, 4 are correspondingly also fixed in position in the vertical direction.

By means of FIGS. 3a to 3d the front-end locking of the two panels 2, 4 will be explained. It is assumed that the long side of the panel 6 has already been connected with the panel 2 and that the panel 4 is to be installed now. For this purpose, its long side is connected with the panel 6 that has already been installed, wherein the two front edges 8, 10 of the panels 2, 4 are aligned with each other. As mentioned, the connection of the long sides is performed by the longitudinal edge of the panel 4 being positioned diagonally to the corresponding longitudinal edge of the panel 6. Subsequently, the panel 4 is angled from its diagonal position to the horizontal, wherein the front-end connection is performed during angling. During the angling of the panel 4, the locking surface 66 of the panel 4 first of all runs on the inclined guiding surface 56 of the profiled slide 16. In accordance with the illustration in FIG. 3a, in its delivery condition the front face 30 of the profiled slide 16 is in contact with the groove ground 28 of the guide groove 26. By the horizontal force component resulting from the running of the locking surface 66 on the guiding surface 56, the profiled slide 16 is moved from its basic position illustrated in FIG. 3a to the right (arrow in FIG. 3b), wherein the guiding surface 56 slides off on the locking surface 66 and hence the locking projection 54 immerses into the locking recess 52.

During the further angling of the panel 4, the support face 62 then gets into contact with the abutment wall 64, wherein the beveled face 48 of the shearing block approaches the horizontal locking surface 46 of the locking lip 22. During the further lowering process of the panel 4, the locked position illustrated in FIG. 2 and explained already in detail will be reached. The profiled slide 16 is thus automatically, without elastic deformation, moved from the release position illustrated in FIG. 3a to the locked position illustrated in FIG. 2 in which the guiding surface 56 and the support face 62 of the profiled slide 16 are in contact with the correspondingly inclined locking surface 66 or the abutment wall 64, respectively.

In the illustrated embodiment the faces 56 and 62 or 66 and 64, respectively, are positioned in parallel to each other—on principle, however, this parallel arrangement or a planar contact of the areas 56, 66 and/or 62, 64 is not required, though.

As explained by means of FIG. 3d, the exact prior positioning of the profiled slide 16 is not cogently necessary. FIG. 3d illustrates the case that the profiled slide, prior to performing the front-end locking, was moved somewhat to the right from its release position. In this case, during angling of the panel 4 first of all the beveled face 70 of the shearing block 18 runs on the front face 58 of the profiled slide 16, such that it is, due to the resulting horizontal force component, first of all moved to the left (arrow in FIG. 3d) into the guide groove 26. During further angling, as illustrated in FIG. 3a, the locking surface 66 then runs on the guiding surface 56, so that the profiled slide 16 is then again moved to the right, in the direction of its locked position. This means that the concept according to the invention is relatively insensitive with respect to an exact prior positioning of the profiled slide 16, so that even if the profiled section 16 is not positioned exactly, the front-end connection can be established without additional effort since the profiled slide so to speak adjusts itself.

By means of FIGS. 4 to 6, a further embodiment of the connection according to the invention will be explained.

The basic structure of the connection illustrated in FIG. 4 corresponds to that of FIG. 2, so that, for the sake of simplicity, only those features of the embodiment of FIG. 4 are dealt with which differ from the afore-described embodiment. As for the rest, reference may be made to the foregoing explanations.

FIG. 4 illustrates the two panels 2, 4 in the locked condition in which the guiding surface 56 and the locking surface 66 are in planar contact with each other and the support face 62 is supported on the abutment wall 64. In the afore-described embodiment, in the case of an uneven underground (underfloor) due to the displacement of the two panels 2, 4 resulting from the unevenness, there might, in the most unfavorable case, occur that the profiled slide 16 is displaced somewhat from the locked position. To avoid this, in the embodiment according to FIG. 4 the contact area between the support face 62 and the abutment wall 64 is not designed to be planar, but punctual or linear. In the concrete embodiment this is effected by the fact that the abutment wall 64 is designed in the kind of a fillet with a radius of curvature which is designed such that the support face 62 cannot get into planar contact. In the illustrated embodiment the abutment wall 64 has a concave curvature, wherein different radii of curvature may be used. Thus, the radius of curvature of the abutment wall 64 following the rear wall 60 is designed to be somewhat larger than in the transition region to the vertical face 68. In the case of a laminate floor with the involved plate thicknesses, the radius of curvature may be in the range of 1 to 5 mm, preferably in the range between 2 and 3 mm.

In the illustrated embodiment the support face 62 is designed as a plane area. On principle, it might also be rounded, wherein the radius of curvature must then be smaller than that of the abutment wall 64 so as to ensure a linear contact. In the case of a planar support face 62 the radius of curvature is chosen such that a contact extends merely along an edge 76 confining the support face 62 while the other edge 78 extends at a small distance to the abutment wall 64 which is not illustrated in FIG. 4. On principle, the radius of curvature may, however, also be chosen such that both edges 76, 78 rest on the abutment wall 64 and a small gap exists between these edges.

A further difference as compared to the embodiment of FIG. 2 consists in that at least one brake bump 80 is formed on the flat slide section 24 which engages behind the front face section 34 in the illustrated locked position, so that the profiled slide 16 can no longer be shifted into the guide groove 26.

FIGS. 5a to 5f illustrate different views of the profiled slide 16.

In particular in the section A-A according to FIG. 5e and in the three-dimensional top view of FIG. 5a and the three-dimensional bottom view of FIG. 5b one recognizes the flat slide portion 26 guided in the guide groove 26 and the locking projection 54 projecting vis-à-vis thereto and having an approximately triangular design. In the illustrated embodiment the flat slide portion 24 is provided with a plurality of recesses or cuts 82, 83, so that a plurality of flat slide teeth 84, 86 are designed, wherein the breadth (view pursuant to FIG. 5d) of the flat slide teeth 84 is distinctly smaller than that of the flat slide teeth 86. Every two narrower flat slide teeth 84 are successively arranged next to every two broader flat slide teeth 86. The depth of the cuts 83 between two adjacent broad flat slide teeth 86 is somewhat smaller than the depth of the other cuts 82 confining the smaller flat slide teeth 84.

As results in particular from FIG. 5a and the side view pursuant to FIG. 5c, a respective brake bump 80 is formed in the region of two respective adjacent broad flat slide teeth 86, said brake bump 80 overstretching the two adjacent flat slide teeth 86, wherein the cut 83 ends shortly before the brake bump 80 extending transversely thereto. This becomes particularly clear in the enlarged top view of the profiled slide 16 pursuant to FIG. 5f. In the region of this brake bump 80 the two adjacent broader flat slide teeth 86 are each provided with an approximately U-shaped clear cut 92 encompassing the respective brake bump 80, wherein shorter legs 94, 96 of the clear cut 92 confine the respective brake bump 80 laterally and taper off in the respective flat slide tooth 86. A basis 98 of the clear cut 92 extends approximately parallel to the locking projection 54 to be seen in FIG. 5f and extends into one of its flanks. This U-shaped clear cut 92 forms a flexible tongue 100 being slotted in the middle by the cut 83 between the adjacent flat slide teeth 86. As results in particular from the views according to FIGS. 5b, 5d and 5e (see section A-A), the height h of the flat slide teeth 86 is reduced relative to the total height H of the flat slide section, wherein the transition is performed by a bevel 102 that may well be seen in FIGS. 5b and 5d. The total height H of the flat slide section 24 is chosen such that it corresponds to the height of the guide groove 26. Accordingly, the broader flat slide teeth 86 are designed with somewhat smaller height h, so that the flexible tongue 100 formed by them is adapted to deflect elastically when the profiled slide 24 is moved within the guide groove 26. The narrower flat slide teeth 84 also have the height H. The large areas of the profiled slide 16 which can be seen in FIGS. 5d (bottom view) and 5f (top view) are designed as sliding faces.

In the basic position of the profiled slide 16, i.e. when no further component 4 has been positioned yet, the brake bumps 80 are positioned within the guide groove 26, wherein this is rendered possible by a slight elastic deflection of the flexible tongue 100. During the positioning process of the other component 4 and the involved moving out of the profiled slide 24 toward the locked position, the brake bumps 80 move back to their position illustrated in FIG. 4 due to the elasticity of the flat slide teeth 86 and the flexible tongues 100 formed thereon and then engage behind the front face section 34 in the locked position—an undesired moving back of the profiled slide 16 toward the release position is then not possible since this is prevented by the brake bumps 80.

During the angling process of the panel 4 that has already been connected with its long side in the direction of the installation position illustrated in FIG. 4, it is first of all positioned diagonally to the panel 2 that has already been installed, so that during the angling process and the involved shifting movement of the profiled slide 16 the support face 62 does not get into contact with the abutment wall 64 along its total length extending perpendicularly to the drawing plane in FIG. 4, but increasingly in the course of the angling process of the panel 4. Pilot tests have shown that this angling movement and a rigid design of the profiled slide 24 may cause “squeezing” in the region in which—depending on the stage of angling—the support face 62 runs into the abutment wall 64. In order to avoid this “squeezing”, the construction of the profiled slide 16 has been chosen such that it can be deflected in the direction of installation, i.e. in the horizontal direction in FIG. 4, so that the afore-described running of the support face 62 into the abutment wall 64 is facilitated since the profiled slide 16 yields, wherein this deflection then propagates in the locking direction in the horizontal plane as a function of the stage of angling in the longitudinal direction through the profiled slide 16 until it has achieved its locked position (the panel 4 is completely angled). In other words, the profiled slide 16 is, viewed in the longitudinal direction, gradually shifted in the direction of its locked position, wherein it is deflected in an approximately s-shaped manner in the region in which the angled panel 4 runs on the installed panel (see FIG. 5a). The profiled slide 16 thus performs an approximately meandering movement. For the sake of illustration, a deflection range is illustrated schematically with a chain dotted line in FIG. 5a. This deflection of the profiled slide is only some hundredths or tenths of a millimeter—the illustration in FIG. 5a is distinctly exaggerated.

By means of FIGS. 6a to 6c the installation process is again explained, wherein, with reference to the corresponding statements with respect to FIGS. 3a to 3c, this will again be done briefly.

At the beginning of the angling process of the panel 4 that has been connected with its long side toward the panel 2 that has already been installed, the connection profile 16 has immersed almost, completely into the guide groove 26. During the angling process, the locking surface 66 runs on the guiding surface 56, so that the connection profile 16 according to FIG. 6b is moved in the direction of its locked position (to the right). In this process, the two faces 56, 66 slide off against each other. After a certain angling distance the support face 62 runs on the transition region between the vertically extending vertical face 68 and the abutment wall 64 that is designed in the kind of a fillet, wherein due to the inclination of the panel 4 with respect to the drawing plane in FIG. 6b this contact area is not available along the entire front edge, but only punctually. Due to the afore-described elasticity of the connection profile 16 it is adapted to twist to some extent to the left in this squeezing area, so that the support face 62 runs into the abutment wall 64 almost without resistance and, as is illustrated in FIG. 6c, is, for instance, with the edge 78 in linear or punctual contact with the abutment wall 64. During the further angling process the support face 62 slides off with the edge 78 at the abutment wall 64 until the locked position according to FIG. 4 has been reached. During this angling movement the connection profile 16 can yield in the squeezing area so as to facilitate the running of the support face 62 into or on the abutment wall 64, respectively.

In the afore-described embodiments the profiled slide 16 is guided in that panel 2 (in general component) that is designed with the extended locking lip 22. With respect to this panel 2 that has already been installed, the panel 4 to be installed will then be angled in the required manner. By means of FIGS. 7a to 7c an embodiment will be explained in which the profiled slide 16 is guided in the panel 4 to be angled. The basic structure of the profiled slide pursuant to FIG. 7a corresponds to that of the afore-described embodiments, so that only some essential elements are explained here and as for the rest, reference may be made to the above explanations with respect to the profiled slide 16. Accordingly, the locking projection 54 which, in accordance with FIG. 7, has an approximately triangular cross-section, is arranged to be oriented downward, while it is arranged to be oriented upward in the afore-described embodiments. The flat slide portion 24 is now guided in the panel 4 that is accordingly provided with the guide groove 26. In the variant illustrated in FIG. 7, a brake bump 18 is also provided which prevents a shifting back of the profiled slide 24 from the illustrated locked position to the release position. In accordance with the illustration in FIG. 7a, the guide groove 26 ends with its front end above the shearing block 18 that is engaged behind by the horizontal locking projection 20 of the locking lip 22.

In the variant pursuant to FIGS. 7a to 7c, the locking recess 52 is accordingly formed in the panel 2 that has already been installed and comprises, similar to the embodiment of FIG. 4, a somewhat rounded abutment wall 64 and a largely plane locking surface 66 that is inclined to the horizontal, wherein the abutment wall 64 is, corresponding to the position orientation of the profiled slide 16, arranged above the locking surface 66.

The two faces 64, 66 are connected with each other by the rear wall 60 of the locking recess 52 which is spaced apart from the front face 58 of the locking projection 54. Its guiding surface 56 is in contact with the locking surface 66 while the support face 62 is in contact with the rounded abutment wall 64. A horizontally extending transition region 102 formed in the transition region between the locking recess 52 and the locking lip 22 of the panel 2 is designed to be spaced apart from the brake bump 80.

The inclined beveled face 70 of the shearing block 18 is also spaced apart from the transition region 102. In the variant pursuant to FIGS. 7a to 7c this inclined face 70 has no other essential function. In the afore-described embodiments the profiled slide 16 is shifted back into the guide groove 26 via the inclined face 70 if the profiled slide 16 projects too far.

FIGS. 7b and 7c illustrate in detail the sections of the panels 2, 4 illustrated in FIG. 7a. As mentioned, the basic structure of the front-end profile is, in the embodiment pursuant to FIGS. 7a to 7c, equivalent to that of the afore-described embodiments, so that further explanations are superfluous. In order to facilitate understanding, the same reference numbers as with the initially described embodiments are used in the above description of the variant pursuant to FIGS. 7a to 7c for elements corresponding to each other.

The positioning of the panel 4 at the panel 2 that has already been installed is performed as already described. The only difference substantially consists in that now the profiled slide 16 is also angled and in this process runs with its guiding surface 56 on the locking surface 66 that is now positioned therebelow in the lowering direction, and is then shifted out of the guide groove 26 until the support face 62 runs on the abutment wall 64. As already mentioned, in all the embodiments described the support face 62 may also be designed linearly. The abutment wall 64 may be curved or substantially plane.

FIG. 8 illustrates a variant of a connection similar to that of the embodiment pursuant to FIG. 7. In the embodiment pursuant to FIG. 8, the circumferential edges of the profiled slide that is illustrated in detail in FIGS. 5a to 5f are chamfered, so that no areas with sharp edges are formed. In the embodiment pursuant to FIG. 11 the chamfer 132 is provided with reference number 132. A further difference with respect to the embodiment pursuant to FIGS. 7a to 7c consists in that the abutment wall 64 is not designed to be concave, but as a plane face. Similar to the embodiment illustrated in FIGS. 7a to 7c, a step 134 is formed in the transition region 102 which comprises a beveled face section and a vertical face section, and by which the space between the beveled face 70 and the transition region 102 of the panel 2 widens toward the top (view pursuant to FIG. 8). As for the rest, the embodiment pursuant to FIG. 8 corresponds to that of FIGS. 7a to 7c, so that further explanations are superfluous.

The profiled slide 16 illustrated in FIG. 9 also has brake bumps 80 formed by clear-cut flexible tongues, said brake bumps 80 fixing the locked position of the profiled slide 16 pursuant to FIG. 8 and preventing inadvertent moving back to the release position. The profiled slide 16 is further designed with the flat slide section 24 and the laterally attached locking projection 54 having an approximately triangular design. It is confined in sections by the guiding surface 56 and the front face 58. The profiled slide 16 illustrated in FIG. 9 is also provided with a chamfer 132. The guiding projection 54 is designed with a slot 130 opening toward the front face 58. In the illustrated embodiment this slot 130 is designed with a fillet-like basis 135 and extends approximately from the central region of the front face 58 toward the flat slide section 24. In the transition region between the front face 58 and the flat slide section 24 the described support face 62 is formed, along which the profiled slide 16 is in contact with the abutment wall 64 in the locked position. The slot 130 awards certain elasticity to the locking projection 54, so that a largely clearance-free contact with the abutment wall 62, on the one hand, and the locking surface 66, on the other hand, is ensured and manufacturing tolerances may be offset. A snap function is, however, not implemented by this slot 130.

As already mentioned, it is preferred if the profiled slide 16 is manufactured by injection molding of plastics, for instance, of glass fiber reinforced plastics, wherein delivery off the “belt” is possible and the profiled slide is then cut to the required length on site. On principle, other suitable materials may, of course, also be chosen.

FIG. 10 illustrates an embodiment of a connection for floor panels which largely corresponds to that pursuant to FIGS. 7a to 7c, so that a repetition of the concurrences may be renounced. Also in the variant illustrated in FIG. 10 the profiled slide 16 is guided in the panel 4 to be angled and immerses with its locking projection 54 into the locking recess 52 in the locked position. The latter is, similar as in the embodiments illustrated in FIGS. 3a to 3d, confined by largely plane faces—the abutment wall 64, the rear wall 60, and the locking surface 66. The latter extends in this embodiment approximately parallel to the abutment wall 64. Correspondingly, the locking projection 54 is designed with the guiding surface 56, the support face 62, and the front face 58, wherein the locking surface 66 and the support face 62 extend in parallel at least in sections. The flat slide portion 24 of the profiled slide 16 is guided in the guide groove 26 of the panel 4 to be installed (to be angled) and has, in accordance with the schematic illustration of FIG. 10, a support nipple 136 projecting from the elastically deflectable flexible tongue 100 indicated in FIG. 10. In the illustrated locked position the support nipple immerses into a cut 138 in the transition region 102 of the panel 2 that has already been installed. In accordance with the illustration in FIG. 10 and in correspondence with the afore-described embodiments, this transition region 102 is followed by the locking lip 22 on which the horizontal locking projection 20 is formed which engages behind the shearing block 18 and thus effects the horizontal locking determining the withdrawal forces. The cut 138 is designed with a bottom-side support face 140 on which the support nipple 136 may be supported. This way, when the floor panel 4 is strained in the direction of the arrow, this force may be introduced into the other panel 2 via the profiled slide 16 and the support nipple 136, so that the initially described formation of an overshot is prevented or at least considerably weakened.

It may absolutely be the case that the support nipple 136 is arranged at some distance to the support face 140 in the normal locked position and gets into its support position only after slight shifting.

It is pointed out again that the vertical lock effective in the direction of withdrawal is not performed via the support nipple 136 since it is merely in resilient contact with the—in FIG. 10—right vertical face 142 of the cut 138 and hence engages there behind, so that the profiled slide 16 is secured from being moved in the direction of its release position—an improvement of the withdrawal force is not or just to a small extent possible by the support nipple 136.

FIG. 11 illustrates a side view of the profiled slide 16. It shows the flat slide section 24, the approximately triangular locking projection 54 with the guiding surface 56, the front face 58 and the support face 62 getting into contact with the abutment wall 64. The support nipple 136 projects from the flat slide section 24 downward, wherein the end section of the support nipple 136 is designed with a taper, so that the support on the support face 140 is performed along a peak 144.

In the profiled slide 16 illustrated in FIG. 11, the visible side face of the locking projection 54 is designed with a chamfer or bevel 148. The chamfer is formed in the region of a peak 150 and/or the guiding surface 56 of the locking projection 54 and becomes effective during the angling process of the one panel toward the panel that has already been installed, so that a somewhat softer contacting takes place due to the beveled or rounded area and hence a squeezing/blocking may be avoided. Although the chamfer/bevel 148 may be formed on both sides of the profiled slide, it is sufficient to apply it only on the side face that is the first to get into contact with the other panel.

FIG. 12a illustrates a section of the profiled slide 16 from the bottom (view pursuant to FIG. 11) while FIG. 12b illustrates a view of the profiled slide 16 in FIG. 11a from the top. The basic structure corresponds to that of the embodiment explained by means of FIG. 5. This means that a plurality of recesses 82 is formed on the flat slide section 24 by which the flat slide teeth 84, 86 are confined. At the somewhat broader flat slide teeth 86 the U-shaped clear cut 92 is formed by which the flexible tongue 100 is formed. At the free end section (parallel to the basis 98) it carries the afore-described support nipple 136 which accordingly orientates itself in parallel to and in the same direction as the locking projection 54. The profiled slide 16 is designed such that the flexible tongue 100, in the non-inserted condition, is bent out of the plane of the flat slide section 24 toward the viewer in FIG. 12a. This can be recognized by the illustration in FIG. 12b which so to speak shows a rear view of the flexible tongue 100. This illustration shows how the free end section of the flexible tongue 100 curves out of the clear cut 92 away from the viewer.

In this embodiment the transverse elasticity of the profiled slide 16 is further increased as compared to the afore-described solutions in that slots 146 are also provided on the side of the locking projection. This means that the transverse elasticity is determined by the recesses 82, 83 in the region of the flat slide section 24 and by the slots 146 arranged in the opposite direction thereto. The latter-mentioned slots 146 extend through the locking projection 54 into the flat slide section 24. Similar to the afore-described embodiment the flexible tongue 100 is also provided with a slot 83.

FIG. 13 illustrates an embodiment in which a profiled slide according to FIGS. 11 and 12 is not guided in the panel 4 to be installed, but in the panel 2 that has already been installed. On principle, the profiled slide 16 has the same structure as explained by means of FIGS. 11 and 12. It immerses with its locking projection 54, which is triangular in the broadest sense, into the locking recess 52 that is now formed on the panel 4 to be installed. The locking recess 52 is formed at a distance to the front face section 36, wherein the horizontal face 72 is formed in the transition region between this front face section 36 and the locking recess 52. The afore-described cut 138 is, in correspondence with kinematic inversion, now formed in the component 4 to be lowered and ends in the horizontal face 72. In the illustrated locked state the support nipple 136 immerses into the cut 138 and engages behind the vertical face 142, so that a moving back of the profiled slide 16 into the guide groove 26 is prevented The horizontal lock is again effected via the locking projection 20 of the locking lip 22 which engages behind the shearing block 18 on the panel 4 to be lowered.

In the same manner as with the afore-described embodiments, the guiding surface 56 of the locking projection 54 of the profiled slide 16 during the angling process gets into contact with the locking surface 66 of the locking recess 52 and is then shifted, by the shifting force effective in the horizontal direction, in the direction of its locked position in the direction to the panel 4 that is being lowered. In this process, the flexible tongue 100 is swiveled into the plane of the flat slide section 24, so that the support nipple 136 slides off the respectively other panel along the horizontal face 72 until it can snap into the cut 138. In the locked position, the support face 62 of the profiled slide 16 is then in contact with the abutment wall 64 of the respectively other component.

For the actual locking it does not play any role whether the profiled slide 16 is guided in the panel 4 to be installed or in the panel 2 that has already been installed.

The connection according to the invention with the profiled slide adapted to be shifted by angling or positioning of a panel can be used with floor as well as with wall and ceiling panels or similar components. They may be manufactured of laminate, but also of wood, for instance as a parquet, or completely or partially of an elastic material, wherein in the latter case the whole component is elastic or may comprise a rigid core of wood, HDF/MDF or a composite material.

The afore-described constructions with a shiftable profiled slide may also be connected at the front end by hitting, for instance, by means of a mallet.

Disclosed is a connection for elastic or rigid components, in particular for floor panels, wherein a profiled slide is adapted to be moved directly from a release position into a locked position by lowering a component relative to a component that has already been installed. This movement may substantially be performed without elastic deformation of a component and/or the profiled slide. It may be guided in the component that has already been installed or in the component to be installed.

### LIST OF REFERENCE NUMBERS

1 Floor covering
2 panel
4 panel
6 panel
8 front edge
10 front edge
12 longitudinal edge
14 longitudinal edge
16 profiled slide
18 shearing block
20 horizontal locking projection
22 locking lip
24 flat slide section
26 guide groove
28 groove bottom
30 front face
32 upper horizontal face
34 front face section
36 front face section
38 effective face
40 lower horizontal face
42 nub
44 vertical face
46 horizontal locking surface
48 beveled face
50 recess
52 locking recess
54 locking projection
56 guiding surface
58 front face
60 rear wall
62 support face
64 abutment wall
66 locking surface
68 vertical face
70 beveled face
72 horizontal face
74 floor face
76 edge
78 edge
80 brake bump
82 recess
83 recess
84 flat slide tooth
86 flat slide tooth
92 clear cut
94 leg
96 leg
98 basis
100 flexible tongue
102 transition region
130 slot
132 chamfer
134 step
135 basis
136 support nipple
138 cut
140 support face
142 vertical face
144 peak
146 slot
148 bevel
150 peak

1. A connection for panel-type components comprising a lock which acts along adjacent lateral edges of the components and which can be brought into engagement by lowering a component relative to a component that has already been installed, wherein a profiled slide is guided in a movable manner on one component, said profiled slide being adapted to be brought into locking engagement with a locking recess on the other component for providing a vertical lock, in that the profiled slide has a locking projection with a first guiding surface which is positioned diagonally with respect to the installation plane and which comes into contact with a locking surface of the locking recess during the lowering process, such that a force component that causes a movement from a release position into a locked position is applied to the profiled slide.

2. The connection according to claim 1, wherein the profiled slide is guided in the component that has been installed or that is to be lowered.

3. The connection according to claim 1, wherein the guiding surface engages behind the locking surface in the locked position, and wherein the locking projection comprises a support face that is at least in sections in contact with an abutment wall of the locking recess in the locked position.

4. The connection according to claim 3, wherein during the lowering process the profiled slide is movable in the locking direction by a force component acting in the locking direction until the support face is at least in sections in contact with the abutment wall in the locked position.

5. The connection according to any of claim 2, wherein the locking surface and the abutment wall are in mutual contact punctually or linearly, wherein this is preferably effected by a curvature of the locking surface and/or the abutment wall.

6. The connection according to claim 1, wherein the pitch angle of the guiding surface relative to the horizontal is between 30° and 60°, preferably approximately 50°.

7. The connection according to claim 1, wherein the locking projection has an approximately triangular shape, with the guiding surface formed at the rear and a front face facing the locking recess which is spaced apart substantially from a rear wall of the locking recess in the locked position.

8. The connection according to claim 7, wherein the locking projection has a slot preferably ending in the front face.

9. The connection according to claim 1, comprising a shearing block provided on the one component or on the other component, said shearing block resting on an extended locking lip of the second or the first component, respectively, in the locked position and is engaged behind by a horizontal locking projection of the locking lip.

10. The connection according to claim 9, wherein the shearing block has a beveled face that is adapted to be brought into contact with the front face if the profiled slide projects too far in the locking direction, so as to move the profiled slide in counter-direction to the locking direction until the guiding surface has been aligned relative to the locking surface.

11. The connection according to claim 1, wherein the profiled slide has a flat slide section guided to be moved in the locking direction in a guiding groove of the one component.

12. The connection according to claim 11, wherein the profiled slide has a plurality of recesses or slots increasing a transverse elasticity of the profiled slide, wherein the recesses or slots end in the flat slide section or in the region of the locking projection and are arranged approximately diagonally to the longitudinal axis of the profiled slide.

13. The connection according to claim 1, wherein flexible tongues projecting from the flat slide plane are formed in the region of the flat slide section.

14. The connection according to claim 13, wherein the flexible tongues are each formed by an area that is cut clear preferably in U-shape.

15. The connection according to claim 13, wherein the rear side of the flexible tongues is slotted.

16. The connection according to claim 13, wherein the flexible tongues have brake bumps.

17. The connection according to claim 13, wherein the flexible tongues have support nipples supported at a support face on the adjacent component.

18. The connection according to claim 17, wherein the support face is formed at a cut into which the support nipple immerses in the locked position and in this process engages behind a vertical face.

19. The connection according to claim 17, wherein the support nipple extends approximately in the same direction as the locking projection.

20. A floor covering comprising a plurality of components connected with each other by means of a connection according to claim 1.

21. A profiled slide for a connection according to claim 1, comprising a flat slide section and a locking projection.

22. The profiled slide according to claim 21, wherein a plurality of recesses or slots are formed in the region of the flat slide section which increase a transverse elasticity of the profiled slide, wherein the recesses or slots end in the flat slide section or in the region of the locking projection and are arranged approximately diagonally to the longitudinal axis of the profiled slide.

23. The profiled slide according to claim 20, wherein at least one flexible tongue is formed in the region of the flat slide section which projects from the flat slide plane.

24. The profiled slide according to claim 23, wherein the respective flexible tongue is formed by an area cut clear preferably in U-shape.

25. The profiled slide according to claim 21, wherein the rear side of the flexible tongue is slotted.

26. The profiled slide according to claim 23, wherein the flexible tongue has a brake bump.

27. The profiled slide according to claim 23, wherein the flexible tongue has a support nipple.

28. The profiled slide according to claim 27, wherein the support nipple extends approximately in the same direction as the locking projection.

29. The profiled slide according to claim 21, wherein a plurality of nubs is formed on the flat slide section.

30. The profiled slide according to claim 21, wherein the locking projection is slotted.

31. The profiled slide according to claim 21, wherein the locking projection is provided with a kind of bevel or chamfer on at least one end section of the profiled slide.
